(19) United States
(12) Patent Application Publication
(10) Pub. No.: US 2026/0010133 A1
(43) Pub. Date: Jan. 8, 2026

(54) INTERNET OF THINGS SYSTEMS, METHODS, AND STORAGE MEDIA FOR DEFORMATION MONITORING OF SMART GAS PIPELINE NETWORKS

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Yaqiang QUAN, Chengdu (CN); Lei HE, Chengdu (CN); Yuefei WU, Chengdu (CN)

(73) Assignee: CHENGDU QINCHUAN IOT TECHNOLOGY CO., LTD., Chengdu (CN)

(21) Appl. No.: 19/325,485

(22) Filed: Sep. 10, 2025

(30) Foreign Application Priority Data
Aug. 15, 2025 (CN) 202511143395.5

(51) Int. Cl. G05B 15/02; G06Q 10/20; G06Q 50/26; G16Y 40/40

(52) U.S. Cl. CPC G05B 15/02; G06Q 10/20; G06Q 50/26; G16Y 40/40

(57) ABSTRACT

An Internet of Things (IoT) system, method, and storage medium for deformation monitoring of smart gas pipeline networks are provided, wherein a gas company management platform in the IoT system is configured to: determine a first deformation rate and a second deformation rate of a local pipeline section of a target pipeline within a preset target time period; determine a target deformation rate of the local pipeline section; adjust a segmentation manner of the local pipeline section; determine a height variation, a monitoring frequency, and a maintenance frequency of the adjusted local pipeline section within the preset target time period; generate a base regulation instruction, a monitoring work order, and a maintenance work order respectively; and respectively send to the gas equipment object platform, the gas maintenance object platform, and the gas maintenance object platform.

### CROSS-REFERENCE TO RELATED APPLICATIONS

This application claims the priority of Chinese Patent Application No. 202511143395.5, filed on Aug. 15, 2025, the contents of each of which are hereby incorporated by reference.

### TECHNICAL FIELD

The present disclosure relates to the field of smart gas, and in particular, to an Internet of Things (IoT) system, method, and storage medium for deformation monitoring of smart gas pipeline networks.

### BACKGROUND

After a gas pipeline is built and put into use, local pipeline sections of the gas pipeline may be prone to various deformations due to gas transportation factors and external environmental factors. The gas transportation factors include variations in gas transportation parameters, vibrations of the gas pipeline caused by gas transportation, or the like, and the external environmental factors include differences in terrain, differences in topography, uneven settlement of soil or foundation, variations in ambient temperature, or the like. Uneven deformations of a plurality of local pipeline sections of the same gas pipeline pose potential safety hazards. However, current pipeline deformation monitoring often requires on-site manual inspection, which is time-consuming and labor-intensive, and lacks timeliness in monitoring.

Therefore, it is desirable to provide an IoT system, method, and non-transitory computer-readable storage medium for deformation monitoring of smart gas pipeline networks, which can evaluate a deformation rate of a local pipeline section in a future time period, so as to accurately generate a corresponding base regulation instruction, a monitoring work order, and a maintenance work order, thereby issuing the base regulation instruction, the monitoring work order, and the maintenance work order to corresponding platforms to realize timely monitoring, adjustment, and maintenance of pipeline network deformation.

### SUMMARY

An IoT system for deformation monitoring of smart gas pipeline networks is provided in one or more embodiments of the present disclosure, the IoT system comprising a government gas supervision management platform, a government gas supervision sensing network platform, a government gas supervision object platform, a gas company sensing network platform, a gas equipment object platform, and a gas maintenance object platform, and the government gas supervision object platform includes a gas company management platform; the government gas supervision management platform is communicatively connected to the gas company management platform via the government gas supervision sensing network platform; the gas equipment object platform and the gas maintenance object platform are communicatively connected to the gas company management platform via the gas company sensing network platform; the gas company management platform is configured to implement the method for deformation monitoring of smart gas pipeline networks.

In one or more embodiments of the present disclosure, a method for deformation monitoring of smart gas pipeline networks is provided. The method is implemented based on the IoT system for deformation monitoring of smart gas pipeline networks, and is executed by the gas company management platform, comprising the following steps. A first deformation rate and a second deformation rate of a local pipeline section of a target pipeline are determined within a preset target time period. A target deformation rate of the local pipeline section is determined based on the first deformation rate and the second deformation rate. A segmentation manner of the local pipeline section is adjusted based on the target deformation rate. A height variation, a monitoring frequency, and a maintenance frequency of the adjusted local pipeline section are determined within the preset target time period based on the target deformation rate of the adjusted local pipeline section, pipeline material data, and pipeline length data. A base regulation instruction is generated based on the height variation, and the base regulation instruction is sent to the gas equipment object platform. A monitoring work order is generated based on the monitoring frequency, and the monitoring work order is sent to the gas maintenance object platform. A maintenance work order is generated based on the maintenance frequency, and the maintenance work order is sent to the gas maintenance object platform.

In one or more embodiments of the present disclosure, a computer-readable storage medium is provided. The storage medium stores one or more sets of computer instructions, and when a computer reads the one or more sets of computer instructions in the storage medium, the computer implements the method for deformation monitoring of smart gas pipeline networks.

### BRIEF DESCRIPTION OF THE DRAWINGS

The present disclosure will be further described by way of exemplary embodiments, which will be described in detail with reference to the accompanying drawings. The exemplary embodiments are not intended to be limiting. In the exemplary embodiments, the same reference numerals refer to the same structures, wherein:

FIG. 1 is a schematic diagram illustrating a platform structure of an IoT system for deformation monitoring of smart gas pipeline networks according to some embodiments of the present disclosure;

FIG. 2 is a flowchart of an exemplary process for deformation monitoring of smart gas pipeline networks according to some embodiments of the present disclosure;

FIG. 3 is an exemplary schematic diagram illustrating a process for determining a first deformation rate according to some embodiments of the present disclosure;

FIG. 4 is an exemplary schematic diagram illustrating a temperature difference prediction model according to some embodiments of the present disclosure; and

FIG. 5 is an exemplary schematic diagram illustrating a process for determining a second deformation rate according to some embodiments of the present disclosure.

### DETAILED DESCRIPTION

A brief introduction will be given below to the drawings required in the description of the embodiments. The drawings do not represent all possible embodiments.

In the embodiments of the present disclosure, when operations executed in steps are described, unless otherwise specified, the sequence of the steps is interchangeable, the steps may be omitted, and other steps may also be included during the operations.

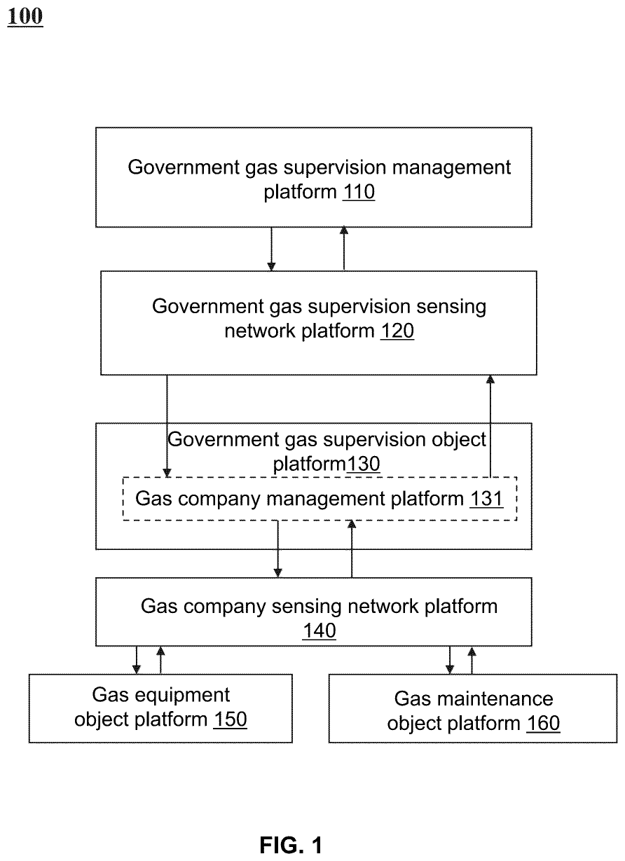

FIG. 1 is a schematic diagram illustrating a platform structure of an IoT system for deformation monitoring of smart gas pipeline networks according to some embodiments of the present disclosure.

In some embodiments, as shown in FIG. 1, an Internet of Things (IoT) system 100 for deformation monitoring of smart gas pipeline networks comprises a government gas supervision management platform 110, a government gas supervision sensing network platform 120, a government gas supervision object platform 130, a gas company sensing network platform 140, a gas equipment object platform 150, and a gas maintenance object platform 160. The government gas supervision object platform 130 may include a gas company management platform 131

The government gas supervision management platform 110 refers to a platform for government supervision and management of gas, and may be configured as a processor, a server, and/or a memory.

The processor may process data and/or information related to the IoT system 100 for deformation monitoring of smart gas pipeline networks. In some embodiments, the processor may include one or more sub-processing devices. Merely by way of example, the processor may include a central processing unit (CPU), an application-specific integrated circuit (ASIC), or any combination thereof.

In some embodiments, the processor may interact with a plurality of platforms included in the IoT system 100 for deformation monitoring of smart gas pipeline networks, or may be configured in the plurality of platforms.

In some embodiments, the government gas supervision management platform 110 may be communicatively connected to the gas company management platform 131 via the government gas supervision sensing network platform 120.

The government gas supervision sensing network platform 120 refers to a platform for government supervision and management of sensing network information related to gas, and may be configured as communication equipment and a gateway.

In some embodiments, the government gas supervision sensing network platform 120 may be used for communication interaction between the government gas supervision management platform 110 and the gas company management platform 131.

The government gas supervision object platform 130 refers to an object platform for generating perception information and executing control information. In some embodiments, the government gas supervision object platform 130 may include the gas company management platform 131.

The gas company management platform 131 refers to an integrated management platform for information related to a gas company, and may be configured as a processor and/or a server and a memory.

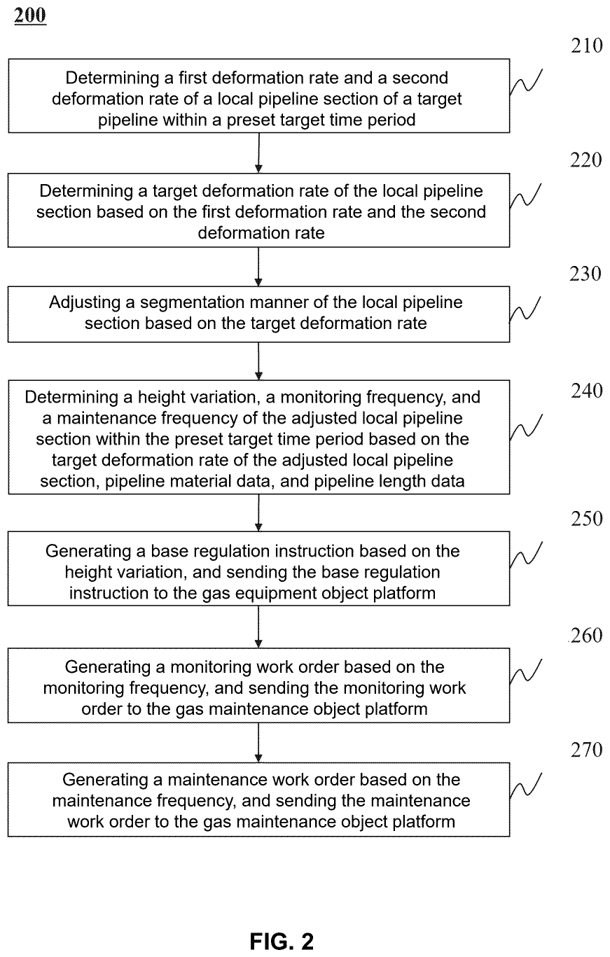

In some embodiments, the gas company management platform 131 may be configured to: determine a first deformation rate and a second deformation rate of a local pipeline section of a target pipeline within a preset target time period; determine a target deformation rate of the local pipeline section based on the first deformation rate and the second deformation rate; adjust a segmentation manner of the local pipeline section based on the target deformation rate; determine a height variation, a monitoring frequency, and a maintenance frequency of the adjusted local pipeline section within the preset target time period based on the target deformation rate of the adjusted local pipeline section, pipeline material data, and pipeline length data; generate a base regulation instruction based on the height variation, and send the base regulation instruction to the gas equipment object platform; generate a monitoring work order based on the monitoring frequency, and send the monitoring work order to the gas maintenance object platform; and generate a maintenance work order based on the maintenance frequency, and send the maintenance work order to the gas maintenance object platform. More descriptions regarding this part may be found in other descriptions of the present disclosure (e.g., descriptions in connection with FIG. 2).

In some embodiments, the gas company management platform 131 is communicatively connected upward to the government gas supervision management platform 110 via the government gas supervision sensing network platform 120, and is communicatively connected downward to the gas equipment object platform 150 and the gas maintenance object platform 160 via the gas company sensing network platform 140.

The gas company sensing network platform 140 refers to an integrated management platform for sensing information of a gas company, and may be configured as a communication network, a gateway, or the like. In some embodiments, the gas company sensing network platform 140 may be used for communication interaction between the gas company management platform 131 and the gas equipment object platform 150 or the gas maintenance object platform 160.

The gas equipment object platform 150 refers to a functional platform for real-time monitoring and intelligent regulation of a gas pipeline network. For example, the gas equipment object platform 150 includes various sensors (e.g., temperature sensors, vibration sensors, or the like) disposed inside a gas pipeline, base equipment disposed outside the gas pipeline, or the like.

The base equipment refers to a base that supports a gas pipeline and is deployed below each local pipeline section. The base equipment may be an electric regulation device. For example, the base equipment may include a bracket with an electromagnetic spring. In some embodiments, when the gas pipeline bends and deforms downward, a height of the base equipment may be lowered to avoid pressing the gas pipeline; when the gas pipeline bends and deforms upward, the height of the base equipment may be raised to provide support for the gas pipeline, thereby effectively slowing down further deformation of the gas pipeline.

The gas maintenance object platform 160 refers to a platform for interaction with gas workers. The gas workers refer to personnel engaged in work related to the gas pipeline network. For example, the gas workers may include a safety inspector, a maintenance worker, a storage and transportation worker, or the like. In some embodiments, the gas maintenance object platform 160 includes at least one interaction device, for example, a mobile phone, a computer, or the like of the gas workers.

In some embodiments of the present disclosure, based on the IoT system for deformation monitoring of smart gas pipeline networks, an information operation closed loop may be formed among the various functional platforms, and coordinated and regular operation may be realized under unified management of the gas company management platform, so as to achieve informatization and intelligence of deformation monitoring of smart gas pipeline networks.

FIG. 2 is a flowchart of an exemplary process for deformation monitoring of smart gas pipeline networks according to some embodiments of the present disclosure. In some embodiments, a process 200 may be implemented based on the IoT system 100 for deformation monitoring of smart gas pipeline networks, and may be executed by the gas company management platform 131. For example, the process 200 may be executed by a processor in the gas company management platform 131. As shown in FIG. 2, the process 200 includes the following operations.

In 210, a first deformation rate and a second deformation rate of a local pipeline section of a target pipeline within a preset target time period are determined.

The target pipeline refers to a gas pipeline to be subjected to deformation prediction. For example, the target pipeline may be an open-air gas pipeline.

The local pipeline section refers to one of a plurality of pipeline sections obtained by segmenting the target pipeline. In some embodiments, a segmentation manner of the local pipeline section may include various manners. For example, the processor may equally divide the target pipeline into a plurality of local pipeline sections according to a preset length.

The preset target time period refers to a preset future time period from a current time point. For example, the preset target time period may be a future week or a future month after the current time point.

The first deformation rate refers to a deformation rate of the target pipeline under the influence of natural environmental factors. Environmental parameters related to pipeline deformation may include an ambient temperature, an ambient humidity, or the like of an environment in which the target pipeline is located. The environmental parameters may be monitored and obtained by sensors deployed outside the target pipeline.

The deformation rate may be represented by a ratio of a pipeline deformation amount to a duration of the preset target time period. The pipeline deformation amount may be characterized by an angle of bending deformation of the target pipeline, a length of expansion or contraction deformation of the target pipeline, or the like.

The second deformation rate refers to a deformation rate of the target pipeline under the influence of gas transportation inside the pipeline. Gas parameters related to pipeline deformation may include a gas flow rate, a gas temperature, a gas pressure, or the like. The gas parameters may be monitored and obtained by sensors deployed inside the target pipeline.

In some embodiments, the processor may determine the first deformation rate and the second deformation rate of the local pipeline section within the preset target time period in various manners.

For example, the processor may obtain the first deformation rate of the local pipeline section in the preset target time period from a first vector database based on an ambient temperature, an ambient humidity at a current time point, and pipeline material data of the local pipeline section.

The pipeline material data may include a pipeline material, a pipeline wall thickness, or the like.

The first vector database may include a plurality of first feature vectors and first labels corresponding to the first feature vectors. The first feature vector may be constructed based on a historical ambient temperature, a historical ambient humidity, and historical pipeline material data corresponding to a historical target time point of a sample local pipeline section. The first label corresponding to the first feature vector may be an actual first deformation rate of the sample local pipeline section corresponding to a historical target time period.

The sample local pipeline section may be a historical local pipeline section of any historical target pipeline. The historical target time point refers to a historical time point identical to the current time point. The historical target time period refers to a historical time period starting from the historical target time point and having the same duration as the preset target time period.

The first label may be represented by a ratio of a historical pipeline deformation amount obtained through manual measurement to a duration of the historical target time period, and may be manually annotated.

The processor may construct a first target vector based on an ambient temperature, an ambient humidity, and the pipeline material data of the local pipeline section at the current time point, and determine one or more first feature vectors having a first similarity with the first target vector greater than a preset similarity threshold by searching the first vector database. An average value of first labels corresponding to the one or more first feature vectors may be calculated and determined as the first deformation rate corresponding to the first target vector.

As another example, the processor may obtain the second deformation rate of the local pipeline section in the preset target time period from a second vector database based on a gas flow rate, a gas temperature, a gas pressure, and the pipeline material data of the local pipeline section at the current time point.

The second vector database may include a plurality of second feature vectors and second labels corresponding to the second feature vectors. The second feature vector may be constructed based on a historical gas flow rate, a historical gas temperature, a historical gas pressure, and historical pipeline material data corresponding to a historical target time point of a sample local pipeline section. The second label corresponding to the second feature vector may be an actual second deformation rate of the sample local pipeline section corresponding to a historical target time period. A manner of obtaining the second label is similar to that of obtaining the first label.

The processor may construct a second target vector based on a gas flow rate, a gas temperature, a gas pressure, and the pipeline material data of the local pipeline section at the current time point, and may obtain the second deformation rate by searching the second vector database. This process is similar to obtaining the first deformation rate by searching the first vector database, and thus will not be described in detail herein.

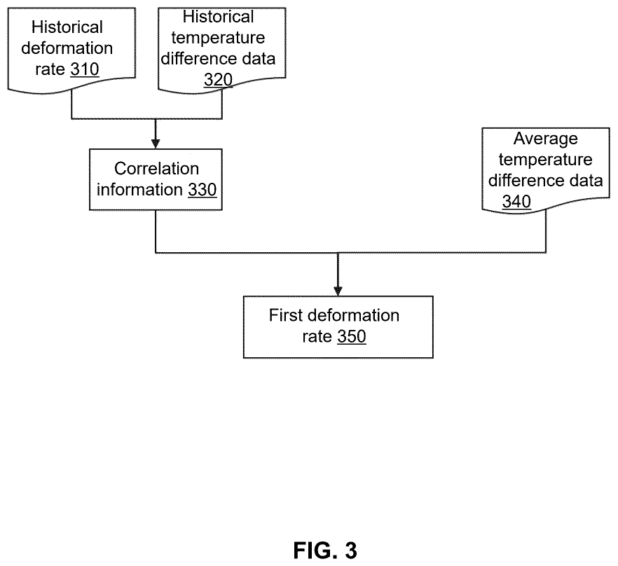

In some embodiments, the processor may generate correlation information between temperature difference data and deformation rate data of the target pipeline based on historical deformation rates and historical temperature difference data of historical local pipeline sections of the target pipeline, and determine the first deformation rate based on average temperature difference data of the local pipeline section within the preset target time period and the correlation information. More descriptions regarding this part may be found in other contents of the present disclosure (e.g., descriptions in connection with FIG. 3).

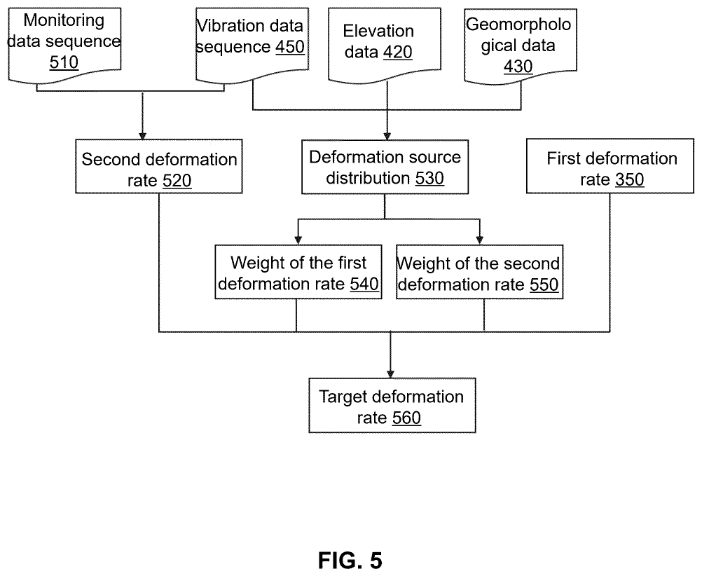

In some embodiments, the processor may obtain a monitoring data sequence and a vibration data sequence of the local pipeline section, and determine the second deformation rate based on the monitoring data sequence and the vibration data sequence. More descriptions regarding this part may be found in other contents of the present disclosure (e.g., descriptions in connection with FIG. 5).

In 220, a target deformation rate of the local pipeline section is determined based on the first deformation rate and the second deformation rate.

The target deformation rate refers to a deformation rate of the local pipeline section estimated by comprehensively considering influences of various factors.

In some embodiments, the processor may perform a weighted summation of the first deformation rate and the second deformation rate of the local pipeline section to obtain the target deformation rate of the local pipeline section.

In some embodiments, a weight of the first deformation rate and a weight of the second deformation rate may be preset manually based on experience.

In some embodiments, the processor may determine a deformation source distribution of the local pipeline section based on the vibration data sequence, elevation data, and geomorphological data, determine the weight of the first deformation rate and the weight of the second deformation rate based on the deformation source distribution, and determine the target deformation rate by performing weighted summation on the first deformation rate and the second deformation rate. More descriptions regarding this part may be found in other contents of the present disclosure (e.g., descriptions in connection with FIG. 5).

In 230, a segmentation manner of the local pipeline section is adjusted based on the target deformation rate.

In some embodiments, for a local pipeline section having a target deformation rate greater than a first preset threshold, the processor may further divide the local pipeline section, and the segmentation manner includes equal segmentation, or the like. For a plurality of consecutive local pipeline sections having a target deformation rate not greater than the first preset threshold, the processor may merge adjacent local pipeline sections, in which a difference in the target deformation rate is less than a second preset threshold, into one local pipeline section. The first preset threshold and the second preset threshold may be preset manually based on experience, and the first preset threshold is greater than the second preset threshold.

In 240, a height variation, a monitoring frequency, and a maintenance frequency of the adjusted local pipeline section are determined within the preset target time period based on the target deformation rate of the adjusted local pipeline section, pipeline material data, and pipeline length data.

In some embodiments, for a plurality of adjusted local pipeline sections obtained through re-segmentation, the processor may recalculate the target deformation rates according to operations 210-220.

The pipeline length data refers to a length of the local pipeline section.

The height variation may be represented by a difference in a pipeline height of the local pipeline section within the preset target time period, and when the pipeline height increases, the height variation is recorded as a positive value. The pipeline height may be represented by a height from a center point of the local pipeline section to the ground.

The monitoring frequency refers to a frequency of performing deformation monitoring on the local pipeline section.

The maintenance frequency refers to a frequency of performing maintenance inspections on the local pipeline section.

In some embodiments, the gas company management platform may determine the height variation, the monitoring frequency, and the maintenance frequency of the adjusted local pipeline section within the preset target time period by querying a preset table based on the target deformation rate, the pipeline material data, and the pipeline length data of the adjusted local pipeline section.

The preset table may include the target deformation rate, the pipeline material data, and the pipeline length data of the local pipeline section, and a corresponding height variation, monitoring frequency, and maintenance frequency of the local pipeline section within the preset target time period. The preset table may be set by technical personnel based on experience.

In 250, a base regulation instruction is generated based on the height variation, and the base regulation instruction is sent to the gas equipment object platform.

The base regulation instruction may include adjusting a height of the base equipment based on the height variation.

In some embodiments, the processor may generate the base regulation instruction based on the height variation according to a preset regulation instruction template.

In some embodiments, the processor in the gas company management platform may send the base regulation instruction to the gas equipment object platform via the gas company sensing network platform, so that the base equipment is adjusted according to the base regulation instruction.

In 260, a monitoring work order is generated based on the monitoring frequency, and the monitoring work order is sent to the gas maintenance object platform.

The monitoring work order may include a local pipeline section to be monitored, a corresponding monitoring frequency, a pipeline inspector, or the like.

In some embodiments, the processor may generate the monitoring work order based on the monitoring frequency according to a preset monitoring work order template.

In some embodiments, the processor in the gas company management platform may send the monitoring work order to the gas maintenance object platform via the gas company sensing network platform, so that the pipeline inspector performs pipeline inspection and monitoring according to the monitoring work order.

In 270, a maintenance work order is generated based on the maintenance frequency, and the maintenance work order is sent to the gas maintenance object platform.

The maintenance work order may include a local pipeline section to be maintained, a corresponding maintenance frequency, a pipeline maintenance worker, or the like.

In some embodiments, the processor may generate the maintenance work order based on the maintenance frequency according to a preset maintenance work order template.

In some embodiments, the processor in the gas company management platform may send the maintenance work order to the gas maintenance object platform via the gas company sensing network platform, so that the pipeline maintenance worker performs pipeline maintenance according to the maintenance work order.

In some embodiments of the present disclosure, by estimating the deformation rate of the local pipeline section caused by various reasons, the segmentation manner of the local pipeline section may be adjusted according to the deformation rate, so that the local pipeline section having a higher deformation rate can be regulated with finer granularity, thereby saving computing resources while improving the regulation effect. Based on the target deformation rate, the pipeline material data, and the pipeline length data of the adjusted local pipeline section, the height variation, the monitoring frequency, and the maintenance frequency of the adjusted local pipeline section within the preset target time period may be accurately determined. Correspondingly, the base regulation instruction, the monitoring work order, and the maintenance work order may be generated and issued to corresponding platforms, so as to achieve precise adjustment of the base equipment of the local pipeline section, as well as timely monitoring, adjustment, and maintenance of the local pipeline section, thereby effectively avoiding a potential risk of excessive deformation of the local pipeline section and facilitating the maintenance of gas pipeline network safety.

It should be noted that the above description regarding the process 200 is merely for purposes of example and illustration, and does not limit the scope of the present disclosure. Various modifications and changes to the process may be made by those skilled in the art in light of the teachings of the present disclosure. However, these modifications and changes still fall within the scope of the present disclosure.

FIG. 3 is an exemplary schematic diagram illustrating a process for determining a first deformation rate according to some embodiments of the present disclosure.

In some embodiments, as shown in FIG. 3, the processor may generate correlation information 330 between temperature difference data and deformation rate data of the target pipeline based on historical deformation rates 310 and historical temperature difference data 320 of historical local pipeline sections of the target pipeline, and for the local pipeline section of the target pipeline, determine the first deformation rate 350 based on average temperature difference data 340 of the local pipeline section within the preset target time period and the correlation information 330.

The historical local pipeline section of the target pipeline refers to a local pipeline section of the target pipeline in historical deformation monitoring.

The historical deformation rate may be represented by a ratio of a historical pipeline deformation amount of a historical local pipeline section to a duration of a corresponding historical time period. The historical pipeline deformation amount and the corresponding historical time period may be obtained based on historical records of deformation monitoring of the target pipeline.

The temperature difference data refers to a difference between temperatures of pipeline outer walls at two ends of the local pipeline section. The historical temperature difference data corresponding to the historical time period may be represented by an average value of temperature difference data at a starting time point of the historical time period and temperature difference data at an ending time point of the historical time period. The historical temperature difference data may also be obtained based on historical records of deformation monitoring of the target pipeline.

The correlation information refers to information reflecting a correspondence relationship between the temperature difference data and the deformation rates. In some embodiments, the correlation information may be represented in a form of a curve. The horizontal coordinate of the correlation information curve may be the temperature difference data, and the vertical coordinate may be the deformation rate.

In some embodiments, for the target pipeline, the processor may construct a numerical point based on the historical deformation rate and the historical temperature difference data of each historical local pipeline section of the target pipeline corresponding to a historical time period; sort a plurality of numerical points in an ascending order according to the historical temperature difference data, perform curve fitting on the numerical points, and take a curve obtained through the curve fitting as the correlation information between the temperature difference data and the deformation rate. The manner for curve fitting may include fitting based on a fitting model (e.g., a polynomial regression model) using a fitting algorithm (e.g., a least squares method).

In some embodiments, the processor may find a corresponding first deformation rate based on the average temperature difference data of the local pipeline section within the preset target time period according to the correlation information.

The average temperature difference data of the local pipeline section within the preset target time period may be represented by an average value of the temperature difference data of the local pipeline section at a starting time point of the preset target time period and the temperature difference data of the local pipeline section at an ending time point of the preset target time period.

In some embodiments, the processor may select one or more pieces of historical temperature difference data corresponding to a historical target time period from the historical temperature difference data, and determine the one piece of historical temperature difference data or an average value of the plurality of pieces of historical temperature difference data as the average temperature difference data of the local pipeline section within the preset target time period. More descriptions regarding the historical target time period may be found in other contents of the present disclosure (e.g., related descriptions in operation 210 of FIG. 2).

In some embodiments, the processor may obtain geomorphological data of the local pipeline section based on the government gas supervision management platform, and determine the average temperature difference data of the local pipeline section within the preset target time period based on current temperature difference data, elevation data, and the geomorphological data of the local pipeline section using a temperature difference prediction model. The temperature difference prediction model is a machine learning model.

The geomorphological data may include a soil type, a vegetation type, a vegetation quantity, a building density, or the like around the local pipeline section. The geomorphological data may be represented in a form of a vector.

In some embodiments, the gas company management platform may directly obtain the geomorphological data of the local pipeline section from the government gas supervision management platform via the government gas supervision sensing network platform.

The current temperature difference data refers to the temperature difference data of the local pipeline section at the current time point. The current temperature difference data may be obtained by the processor based on monitoring data uploaded by temperature sensing devices installed at two ends of the local pipeline section.

The elevation data refers to an altitude at which the local pipeline section is located. The elevation data may be monitored and obtained by an altitude measuring instrument installed on the local pipeline section.

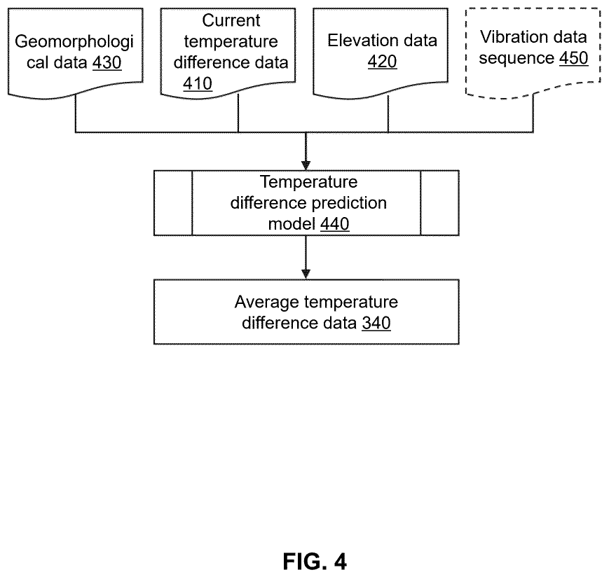

FIG. 4 is an exemplary schematic diagram illustrating a temperature difference prediction model according to some embodiments of the present disclosure.

In some embodiments, as shown in FIG. 4, the processor may determine the average temperature difference data 340 of the local pipeline section within the preset target time period based on current temperature difference data 410, elevation data 420, and geomorphological data 430 of the local pipeline section using a temperature difference prediction model 440.

In some embodiments, the temperature difference prediction model may be a machine learning model. For example, the temperature difference prediction model may be a neural network (NN), or the like.

In some embodiments, as shown in FIG. 4, inputs of the temperature difference prediction model 440 may include the current temperature difference data 410, the elevation data 420, and the geomorphological data 430 of the local pipeline section, and an output of the temperature difference prediction model 440 may be the average temperature difference data 340 of the local pipeline section within the preset target time period.

In some embodiments, the temperature difference prediction model may be trained and obtained in various manners. For example, the processor may train and obtain the temperature difference prediction model using a plurality of training samples with training labels.

In some embodiments, training samples of the temperature difference prediction model may include basic samples and enhanced samples. The basic samples include sample temperature difference data, sample elevation data, and sample geomorphological data of sample local pipeline sections. The enhanced samples include historical temperature difference data, historical elevation data, and historical geomorphological data of the local pipeline section. A sample loss weight of the enhanced samples in a loss function is greater than a sample loss weight of the basic samples in the loss function.

The sample temperature difference data, the sample elevation data, and the sample geomorphological data of the sample local pipeline section respectively refer to the historical temperature difference data, the historical elevation data, and the historical geomorphological data of the sample local pipeline section at a historical target time point. The first training label corresponding to the basic sample is actual average temperature difference data of the sample local pipeline section in a historical target time period. The first training label may be obtained and annotated manually based on historical data.

The enhanced sample includes the historical temperature difference data, the historical elevation data, and the historical geomorphological data of the local pipeline section of the target pipeline at a historical target time point, and a second training label corresponding to the enhanced sample is actual average temperature difference data of the local pipeline section in a historical target time period. The second training label may be obtained and annotated manually based on historical data.

The basic samples correspond to historical data of the historical local pipeline sections of any historical target pipeline. The enhanced samples correspond to historical data of the local pipeline sections of the current target pipeline. More descriptions regarding the sample local pipeline section, the historical target time point, and the historical target time period may be found in other contents of the present disclosure (e.g., related descriptions in operation 210 of FIG. 2).

In some embodiments, the temperature difference prediction model may be trained and obtained using a plurality of basic samples with first training labels. The processor may input the plurality of basic samples with the first training labels into an initial temperature difference prediction model, construct the loss function based on output results of the initial temperature difference prediction model and the first training labels, and iteratively update the initial temperature difference prediction model based on the loss function. When a preset condition is satisfied, model training is completed to obtain a trained temperature difference prediction model. The preset condition may be convergence of the loss function, a count of iterations reaching a threshold, or the like. The iterative updating manner may include, but is not limited to, a gradient descent method.

In some embodiments, the temperature difference prediction model may also be trained and obtained using a plurality of enhanced samples with second training labels, together with a plurality of basic samples with first training labels.

In some embodiments, when the temperature difference prediction model is trained using the plurality of enhanced samples and the plurality of basic samples, the sample loss weight of the enhanced samples in the loss function is greater than the sample loss weight of the basic samples in the loss function.

In some embodiments of the present disclosure, by training the temperature difference prediction model with the enhanced samples and the basic samples, the generalization capability of the model may be improved. In addition, by increasing the weight of the enhanced samples, the temperature difference prediction model pays more attention to data of the local pipeline section of the target pipeline during training, thereby improving the accuracy and reliability of the obtained model.

In some embodiments, as shown in FIG. 4, inputs of the temperature difference prediction model 440 further include a vibration data sequence 450 of the local pipeline section.

The vibration data sequence may be formed by arranging, in chronological order, pipeline vibration data sampled at a plurality of historical sampling time points before the current time point. The pipeline vibration data may include vibration intensity, vibration frequency, or the like of the local pipeline section. The pipeline vibration data may be monitored and obtained by a vibration sensor installed on the local pipeline section.

The historical time period formed by the plurality of historical sampling time points before the current time point is referred to as a target sampling time period. That is, in current deformation monitoring, the target sampling time period is before the current time point, and the preset target time period is after the current time point; in historical deformation monitoring, the historical sampling time period is before the historical target time point, and the historical target time period is after the historical target time point. The target sampling time period corresponds to the historical sampling time period, and the historical sampling time period is a historical time period identical to the target sampling time period.

In some embodiments, the basic samples further include sample vibration data sequences of the sample local pipeline sections, and the enhanced samples further include a historical vibration data sequence of the local pipeline section, so as to train the temperature difference prediction model.

In some embodiments of the present disclosure, vibration of the local pipeline section may cause slight deformation of the pipeline (e.g., the target pipeline), thereby affecting a temperature difference between two ends of the pipeline. By adding the vibration data sequence as an input of the temperature difference prediction model, the temperature difference prediction model can better capture a relationship between the vibration data and the deformation rate, thereby making the prediction of the temperature difference data more accurate.

In some embodiments, after the temperature difference prediction model is trained for a preset number of epochs, the processor may adjust a learning rate of the temperature difference prediction model based on a decay factor. The preset number of epochs is determined based on a geomorphological difference and an elevation difference among local pipeline sections.

In some embodiments, the processor may calculate a vector distance of the geomorphological data between each pair of adjacent local pipeline sections of the target pipeline, and determine a standard deviation of a plurality of vector distances as the geomorphological difference. The vector distance may be Euclidean distance, or the like.

In some embodiments, the processor may determine a standard deviation of the elevation data of all local pipeline sections of the target pipeline as the elevation difference.

In some embodiments, the processor may determine the preset number of epochs based on the geomorphological difference and the elevation difference among the local pipeline sections of the target pipeline. For example, the processor may perform a weighted summation of the geomorphological difference and the elevation difference to obtain the preset number of epochs.

In some embodiments, a value of the decay factor may be in a range of 0 to 1, and may be set manually based on experience.

In some embodiments, after the temperature difference prediction model is trained for the preset number of epochs, the processor may multiply the learning rate of the temperature difference prediction model by the decay factor, and continue to train the temperature difference prediction model according to the adjusted learning rate.

In some embodiments of the present disclosure, by multiplying the learning rate by the decay factor after the preset number of epochs of training, the temperature difference prediction model can converge quickly in an early stage of training, and finely adjust parameters with smaller steps in a later stage of training, thereby effectively avoiding oscillation or failure of convergence during training, and improving accuracy and stability of the temperature difference prediction model.

In some embodiments of the present disclosure, based on the current temperature difference data, the elevation data, and the geomorphological data of the local pipeline section, the trained temperature difference prediction model may be used to quickly and accurately predict temperature difference changes in a future time period, which facilitates early identification of the local pipeline section with a large temperature difference change, so that appropriate measures can be taken in advance.

In some embodiments of the present disclosure, based on the historical deformation rate and the historical temperature difference data, the correlation information between the temperature difference data and the deformation rate of a pipeline may be accurately constructed, and accordingly, for the local pipeline section, the corresponding first deformation rate may be quickly determined through the correlation information and the temperature difference data.

FIG. 5 is an exemplary schematic diagram illustrating a process for determining a second deformation rate according to some embodiments of the present disclosure.

In some embodiments, as shown in FIG. 5, the processor may obtain a monitoring data sequence 510 and a vibration data sequence 450 of the local pipeline section, and determine a second deformation rate 520 based on the monitoring data sequence 510 and the vibration data sequence 450.

The monitoring data sequence may be composed of pipeline gas data sampled at a plurality of historical sampling time points before the current time point and arranged in a chronological order. The pipeline gas data may include a gas temperature, a gas flow rate, a gas pressure inside the local pipeline section, or the like. The pipeline gas data may be monitored and obtained by sensors installed inside the local pipeline section. More descriptions regarding the plurality of historical sampling time points before the current time point may be found in other contents of the present disclosure (e.g., descriptions in connection with FIG. 4).

In some embodiments, for the current local pipeline section, the processor may determine the second deformation rate based on the monitoring data sequence and the vibration data sequence through cluster analysis.

The processor may construct a plurality of clustering vectors based on a plurality of historical monitoring data sequences and historical vibration data sequences corresponding to a plurality of historical sampling time periods of a plurality of sample local pipeline sections, and label actual second deformation rates of the sample local pipeline sections corresponding to the historical target period as clustering labels corresponding to the clustering vectors.

The processor may construct a current vector based on the monitoring data sequence and the vibration data sequence of the current local pipeline section; perform clustering on the plurality of clustering vectors and the current vector to obtain a plurality of clustering clusters; determine the clustering cluster to which the current vector belongs as a target clustering cluster; calculate a mean value of the clustering labels corresponding to all the clustering vectors in the target clustering cluster; and determine the mean value as the second deformation rate corresponding to the current local pipeline section. The clustering method may include, but is not limited to, a K-means clustering algorithm or the like.

In some embodiments of the present disclosure, by combining the monitoring data and the vibration data, the operating state of the pipeline may be evaluated from multiple aspects, enabling a more accurate prediction of the deformation rate of the local pipeline section.

In some embodiments, as shown in FIG. 5, the processor may further determine a deformation source distribution 530 of the local pipeline section based on the vibration data sequence 450, the elevation data 420, and the geomorphological data 430; determine a weight 540 of the first deformation rate and a weight 550 of the second deformation rate based on the deformation source distribution 530; and determine a target deformation rate 560 by performing weighted summation on the first deformation rate 350 and the second deformation rate 520.

The deformation source distribution may include degrees of influence of environmental parameters and gas parameters on the deformation of the local pipeline section. More descriptions regarding the environmental parameters and the gas parameters may be found in other contents of the present disclosure (e.g., descriptions in connection with operation 210 of FIG. 2).

In some embodiments, the processor may construct a plurality of pieces of regression data based on a plurality of vibration data sequences of a sample local pipeline section in a plurality of historical sampling time periods, and the elevation data and the geomorphological data at a plurality of historical target time points; take an actual deformation rate of the sample local pipeline section in a historical target period as a regression label corresponding to the piece of regression data; construct a plurality of regression equations based on the plurality of piece of regression data and the corresponding regression labels; fit, through a regression algorithm, to obtain weight coefficients respectively corresponding to the vibration data sequence, the elevation data, and the geomorphological data of the local pipeline section; determine a degree of influence of the gas parameters on deformation of the local pipeline section according to the weight coefficient of the vibration data sequence; and determine a sum of the weight coefficients of the elevation data and the geomorphological data as a degree of influence of the environmental parameters on deformation of the local pipeline section. The regression algorithm may include, but is not limited to, linear regression, polynomial regression, support vector regression, or the like.

Merely by way of example, a regression equation is as follows:

$${W}_{1} \times {S}_{1} + {W}_{2} \times {H}_{i} + {W}_{3} \times {T}_{i} = {y}_{i}$$

wherein (Sᵢ [symbol] Hᵢ [symbol] Tᵢ) denote an i-th piece of regression data, and a corresponding regression label is yᵢ, i.e., Sᵢ, Hᵢ, and Tᵢ respectively denote a vibration data sequence, elevation data, and geomorphological data in the i-th piece of regression data; W₁, W₂, and W₃ respectively denote the weight coefficients of the vibration data sequence, the elevation data, and the geomorphological data, i.e., W₁ denotes the degree of influence of gas parameters on the deformation of the local pipeline section, and W₂ and W₃ denote the influence degree of environmental parameters on the deformation of the local pipeline section.

In some embodiments, the processor may determine the degree of influence of the gas parameters on deformation of the local pipeline section as a weight coefficient of the second deformation rate, determine the degree of influence of the environmental parameters on deformation of the local pipeline section as a weight coefficient of the first deformation rate, and determine the target deformation rate by performing weighted summation on the first deformation rate and the second deformation rate according to the corresponding weight coefficients.

In some embodiments of the present disclosure, by combining the vibration data, the elevation data, and the geomorphological data, it is possible to assess the degrees of influence of different factors on pipeline deformation, so as to determine the factor that plays a dominant role in the pipeline deformation, and thereby accurately predict the target deformation rate of the local pipeline section.

In some embodiments, the processor may adjust an opening degree of a gas regulating valve within the local pipeline section based on the second deformation rate.

The opening degree of the gas regulating valve refers to an opening degree of a valve for regulating a gas flow rate within the local pipeline section, which may be represented as a percentage from 0% to 100%.

In some embodiments, in response to the second deformation rate of the local pipeline section exceeding a third preset threshold, the processor may decrease the opening degree of the gas regulating valve so as to reduce the gas flow rate within the local pipeline section until the second deformation rate is less than the third preset threshold.

In some embodiments, the third preset threshold is negatively correlated with a vibration frequency in pipeline vibration data of the local pipeline section. More descriptions regarding the pipeline vibration data may be found in other contents of the present disclosure (e.g., descriptions in connection with FIG. 4).

In some embodiments of the present disclosure, by adjusting the opening degree of the gas regulating valve based on the second deformation rate, the gas flow rate and the gas pressure within the local pipeline section can be accurately controlled, thereby avoiding severe deformation of the local pipeline section caused by large temperature differences, pressure fluctuations, or excessive vibrations, and reducing the risk of pipeline damage.

In some embodiments of the present disclosure, a non-transitory computer-readable storage medium is further provided, wherein the non-transitory computer-readable storage medium stores one or more sets of computer instructions, and when a computer reads the one or more sets of computer instructions in the non-transitory computer-readable storage medium, the computer implements the method for deformation monitoring of smart gas pipeline networks according to any one of the above embodiments.

The embodiments of the present disclosure are merely for purposes of example and illustration, and are not intended to limit the scope of the present disclosure. Various modifications and changes that may be made by those skilled in the art in light of the teachings of the present disclosure still fall within the scope of the present disclosure.

In addition, certain features, structures, or characteristics in one or more embodiments of the present disclosure may be suitably combined.

If there is any inconsistency or conflict between the descriptions, definitions, and/or the use of terms in the accompanying materials of the present disclosure and those in the present disclosure, the descriptions, definitions, and/or the use of terms in the present disclosure shall prevail.

What is claimed is:

1. An Internet of Things (IoT) system for deformation monitoring of smart gas pipeline networks, wherein the IoT system comprises: a government gas supervision management platform, a government gas supervision object platform, a gas equipment object platform, and a gas maintenance object platform; the government gas supervision object platform includes a gas company management platform; wherein
the gas company management platform is configured to:
determine a first deformation rate and a second deformation rate of a local pipeline section of a target pipeline within a preset target time period;
determine a target deformation rate of the local pipeline section based on the first deformation rate and the second deformation rate;
adjust a segmentation manner of the local pipeline section based on the target deformation rate;
determine a height variation, a monitoring frequency, and a maintenance frequency of the adjusted local pipeline section within the preset target time period based on the target deformation rate of the adjusted local pipeline section, pipeline material data, and pipeline length data;
generate a base regulation instruction based on the height variation, and send the base regulation instruction to the gas equipment object platform;
generate a monitoring work order based on the monitoring frequency, and send the monitoring work order to the gas maintenance object platform; and
generate a maintenance work order based on the maintenance frequency, and send the maintenance work order to the gas maintenance object platform.

2. The IoT system of claim 1, wherein the gas company management platform is further configured to:
generate correlation information between temperature difference data and deformation rate data of the target pipeline based on historical deformation rates and historical temperature difference data of historical local pipeline sections of the target pipeline; and
for the local pipeline section of the target pipeline, determine the first deformation rate based on average temperature difference data of the local pipeline section within the preset target time period and the correlation information.

3. The IoT system of claim 2, wherein the gas company management platform is further configured to:
obtain geomorphological data of the local pipeline section based on the government gas supervision management platform; and
determine the average temperature difference data of the local pipeline section within the preset target time period based on current temperature difference data, elevation data, and the geomorphological data of the local pipeline section using a temperature difference prediction model, the temperature difference prediction model being a machine learning model.

4. The IoT system of claim 3, wherein training samples of the temperature difference prediction model include basic samples and enhanced samples,
the basic samples include sample temperature difference data, sample elevation data, and sample geomorphological data of sample local pipeline sections,
the enhanced samples include the historical temperature difference data, historical elevation data, and historical geomorphological data of the local pipeline section; and
a sample loss weight of the enhanced samples in a loss function is greater than a sample loss weight of the basic samples in the loss function.

5. The IoT system of claim 3, wherein an input of the temperature difference prediction model further includes a vibration data sequence of the local pipeline section.

6. The IoT system of claim 3, wherein the gas company management platform is further configured to:
after the temperature difference prediction model is trained for a preset number of epochs, adjust a learning rate of the temperature difference prediction model based on a decay factor, the preset number of epochs being determined based on a geomorphological difference and an elevation difference among local pipeline sections.

7. The IoT system of claim 1, wherein the gas company management platform is further configured to:
obtain a monitoring data sequence and the vibration data sequence of the local pipeline section; and
determine the second deformation rate based on the monitoring data sequence and the vibration data sequence.

8. The IoT system of claim 7, wherein the gas company management platform is further configured to:
determine a deformation source distribution of the local pipeline section based on the vibration data sequence, the elevation data, and the geomorphological data; and
determine a weight of the first deformation rate and a weight of the second deformation rate based on the deformation source distribution, and determine the target deformation rate by performing a weighted summation of the first deformation rate and the second deformation rate.

9. The IoT system of claim 7, wherein the gas company management platform is further configured to:
adjust an opening degree of a gas regulating valve within the local pipeline section based on the second deformation rate.

10. The IoT system of claim 1, further comprising a government gas supervision sensing network platform and a gas company sensing network platform, wherein
the government gas supervision management platform is communicatively connected to the gas company management platform via the government gas supervision sensing network platform, and
the gas equipment object platform and the gas maintenance object platform are communicatively connected to the gas company management platform via the gas company sensing network platform.

11. A method for deformation monitoring of smart gas pipeline networks, wherein the method is implemented based on an Internet of Things (IoT) system for deformation monitoring of smart gas pipeline networks, the IoT system comprises a government gas supervision management platform, a government gas supervision sensing network platform, a government gas supervision object platform, a gas company sensing network platform, a gas equipment object platform, and a gas maintenance object platform, and the government gas supervision object platform includes a gas company management platform; wherein
the method is executed by the gas company management platform, the method comprising:
determining a first deformation rate and a second deformation rate of a local pipeline section of a target pipeline within a preset target time period;
determining a target deformation rate of the local pipeline section based on the first deformation rate and the second deformation rate;
adjusting a segmentation manner of the local pipeline section based on the target deformation rate;
determining a height variation, a monitoring frequency, and a maintenance frequency of the adjusted local pipeline section within the preset target time period based on the target deformation rate of the adjusted local pipeline section, pipeline material data, and pipeline length data;
generating a base regulation instruction based on the height variation, and sending the base regulation instruction to the gas equipment object platform;
generating a monitoring work order based on the monitoring frequency, and sending the monitoring work order to the gas maintenance object platform; and
generating a maintenance work order based on the maintenance frequency, and sending the maintenance work order to the gas maintenance object platform.

12. The IoT method of claim 11, wherein the determining a local pipeline section of a target pipeline, a first deformation rate, and a second deformation rate within a preset target time period includes:
generating correlation information between temperature difference data and deformation rate data of the target pipeline based on historical deformation rates and historical temperature difference data of historical local pipeline sections of the target pipeline; and
for the local pipeline section of the target pipeline, determining the first deformation rate based on average temperature difference data of the local pipeline section within the preset target time period and the correlation information.

13. The IoT method of claim 12, further comprising:
obtaining geomorphological data of the local pipeline section based on the government gas supervision management platform; and
determining the average temperature difference data of the local pipeline section within the preset target time period based on current temperature difference data, elevation data, and the geomorphological data of the local pipeline section using a temperature difference prediction model, the temperature difference prediction model being a machine learning model.

14. The IoT method of claim 13, wherein training samples of the temperature difference prediction model include basic samples and enhanced samples,
the basic samples include sample temperature difference data, sample elevation data, and sample geomorphological data of sample local pipeline sections;
the enhanced samples include the historical temperature difference data, historical elevation data, and historical geomorphological data of the local pipeline section; and
a sample loss weight of the enhanced samples in a loss function is greater than a sample loss weight of the basic samples in the loss function.

15. The IoT system of claim 13, wherein an input of the temperature difference prediction model further includes a vibration data sequence of the local pipeline section.

16. The IoT method of claim 13, further comprising:
after the temperature difference prediction model is trained for a preset number of epochs, adjusting a learning rate of the temperature difference prediction model based on a decay factor, the preset number of epochs being determined based on a geomorphological difference and an elevation difference among local pipeline sections.

17. The IoT method of claim 11, wherein the determining a local pipeline section of a target pipeline, a first deformation rate, and a second deformation rate within a preset target time period further includes:
obtaining a monitoring data sequence and the vibration data sequence of the local pipeline section; and
determining the second deformation rate based on the monitoring data sequence and the vibration data sequence.

18. The IoT method of claim 15, further comprising:
determining a deformation source distribution of the local pipeline section based on the vibration data sequence, the elevation data, and the geomorphological data; and
determining a weight of the first deformation rate and a weight of the second deformation rate based on the deformation source distribution, and determining the target deformation rate by performing a weighted summation of the first deformation rate and the second deformation rate.

19. The IoT method of claim 17, further comprising:
adjusting an opening degree of a gas regulating valve within the local pipeline section based on the second deformation rate.

20. A non-transitory computer-readable storage medium, wherein the storage medium stores one or more sets of computer instructions, and when a computer reads the one or more sets of computer instructions, the computer implements a method for deformation monitoring of smart gas pipeline networks, wherein the method is implemented based on an Internet of Things (IoT) system for deformation monitoring of smart gas pipeline networks, the IoT system comprises a government gas supervision management platform, a government gas supervision sensing network platform, a government gas supervision object platform, a gas company sensing network platform, a gas equipment object platform, and a gas maintenance object platform, and the government gas supervision object platform includes a gas company management platform; wherein
the method is executed by the gas company management platform, the method comprising:
determining a first deformation rate and a second deformation rate of a local pipeline section of a target pipeline within a preset target time period;
determining a target deformation rate of the local pipeline section based on the first deformation rate and the second deformation rate;
adjusting a segmentation manner of the local pipeline section based on the target deformation rate;
determining a height variation, a monitoring frequency, and a maintenance frequency of the adjusted local pipeline section within the preset target time period based on the target deformation rate of the adjusted local pipeline section, pipeline material data, and pipeline length data;
generating a base regulation instruction based on the height variation, and sending the base regulation instruction to the gas equipment object platform;
generating a monitoring work order based on the monitoring frequency, and sending the monitoring work order to the gas maintenance object platform; and
generating a maintenance work order based on the maintenance frequency, and sending the maintenance work order to the gas maintenance object platform.
